(19) United States
(12) Patent Application Publication
(10) Pub. No.: US 2025/0134637 A1
(43) Pub. Date: May 1, 2025

(54) COLLAPSIBLE ORAL IRRIGATOR

(71) Applicant: WATER PIK, INC., Fort Collins, CO (US)

(72) Inventor: Thomas A. Bondurant, Fort Collins, CO (US)

(21) Appl. No.: 18/686,758

(22) PCT Filed: Aug. 22, 2022
(86) PCT No.: PCT/US2022/041043

§ 371 Date: Feb. 26, 2024

Related U.S. Application Data
(60) Provisional application No. 63/237,875, filed on Aug. 27, 2021.

(51) Int. Cl. A61C 17/02

(52) U.S. Cl. CPC A61C 17/0202

(57) ABSTRACT

An oral irrigator is disclosed. The oral irrigator may include a housing defining a housing cavity and a chassis received within the housing cavity. A plurality of components received within the housing cavity are mounted to the chassis and inserted into the housing cavity via the chassis.

### CROSS REFERENCE TO RELATED APPLICATIONS

This application claims priority to U.S. Provisional Application No. 63/237,875 titled “Collapsible Oral Irrigator,” which is incorporated by reference herein for all purposes.

### TECHNICAL FIELD

One or more embodiments of the present disclosure relate generally to oral health devices, such as oral irrigators.

### BACKGROUND

Many people use a variety of oral health devices, such as toothbrushes and oral irrigators, to maintain and improve oral health. Often, electrically powered oral health devices may be bulky and take up significant counter space, as well as are difficult to travel with or otherwise be portable. Also, many oral irrigators may be prone to corrosion or other issues as fluid, such as water or mouthwash, may leak from certain areas (either external or internal leakage) and reach electrical components, such as a motor, batteries, circuit board, or the like, damaging these electrical components. Further, many oral health devices may be difficult to assemble, increasing the manufacturing time and/or costs. For example, some oral health devices require each part be individually anchored in place. As such, there is a need in the art for a more portable oral health device that may be easy to assemble, as well as an oral health device that may prevent fluid ingress into select areas.

### SUMMARY

According to one or more embodiments of the present disclosure, an oral irrigator is disclosed. The oral irrigator may include a housing defining a housing cavity and a chassis received within the housing cavity. A plurality of components received within the housing cavity are mounted to the chassis and inserted into the housing cavity via the chassis.

According to one or more embodiments of the present disclosure, all of the components received within the chassis are secured to the chassis. In some embodiments, the housing may include a first alignment feature and the chassis comprises a second alignment feature, where the first alignment feature and the second alignment feature engage to align the chassis within the housing cavity.

According to one or more embodiments of the present disclosure, the first alignment feature and the second alignment feature are secured together to anchor the chassis in position within the housing cavity.

According to one or more embodiments of the present disclosure, the first alignment feature includes two ribs and the second alignment feature includes an edge of the chassis.

According to one or more embodiments of the present disclosure, the first alignment feature comprises a post and the second alignment feature comprises a tab that seats on the post.

According to one or more embodiments of the present disclosure, the housing further comprises a reservoir aperture defined through a bottom surface thereof and a boss surrounding the reservoir aperture and the chassis comprises a drain port, where the drain port interacts with the boss to align the chassis within the housing such that the drain port aligns with the reservoir aperture.

According to one or more embodiments, the plurality of components comprise a motor, a gear driven by the motor, a piston, a connecting rod including a first end coupled to the gear and a second end coupled to the piston, and a pump body defining a pump chamber in which the piston is received, where the chassis defines a wall at least partially surrounding the first end of the connecting rod, and where the pump body includes a cap that covers the wall to enclose the first end of the connecting rod.

According to one or more embodiments of the present disclosure, the motor and the connecting rod are positioned on opposite sides of the chassis.

According to one or more embodiments of the present disclosure, the plurality of components includes a battery, where the battery is positioned along an edge of the chassis adjacent the motor and the connecting rod.

According to one or more embodiments of the present disclosure, the plurality of components further comprises a seal positioned between the wall and the cap to seal an interface between the wall and the cap.

According to one or more embodiments of the present disclosure, the seal is overmolded to an outer edge of the wall.

According to one or more embodiments of the present disclosure, the cap comprises at least one securing tab configured to secure the cap to the wall.

According to one or more embodiments of the present disclosure, the wall interacts with the housing to align the chassis with the housing.

According to one or more embodiments of the present disclosure, an oral irrigator is disclosed. The oral irrigator including a housing, a tip coupled to the housing, a reservoir coupled to the housing and in fluid communication with the tip, a pump coupled to the housing and configured to pump fluid from the reservoir to the tip, and a vent tube positioned within the housing, the vent tube fluidly coupled to the reservoir from the external environment.

According to one or more embodiments of the present disclosure, where the oral irrigator includes a vent positioned over a first end of the vent to prevent water from entering into the vent tube.

According to one or more embodiments of the present disclosure, the vent tube is defined as a flow passage in a wall of the housing.

According to one or more embodiments of the present disclosure, the flow passage is fluidly coupled to the reservoir by a first vent hold extending through a bottom surface of the housing at a first end of the flow passage and the flow passage is fluidly coupled to a latch compartment by a second vent holt at a second end of the flow passage. According to one or more embodiments of the present disclosure, a vent cover is positioned over the second vent whole to prevent water from entering into the latch compartment.

According to one or more embodiments of the present disclosure, a hose is positioned between the pump and the reservoir that fluidly couples the reservoir to the pump.

According to one or more embodiments of the present disclosure, the reservoir of the oral irrigator is movable between a first position and a second position.

According to one or more embodiments of the present disclosure, an oral irrigator is disclosed. The oral irrigator may include a reservoir, a housing, and a pump coupled to the housing and configured to pump fluid from the reservoir to a tip. The pump may include a pump chamber, a piston positioned within the pump chamber, a first piston seal positioned around the piston and configured to seal against an interior wall of the piston chamber, and a second piston seal positioned around the piston and configured to seal against the interior wall of the piston chamber, where the first piston seal is arranged in a first orientation relative to the piston and the second piston seal is arranged in a second orientation, different from the first orientation relative to the piston.

According to one or more embodiments of the present disclosure, the first piston seal and the second piston seal each comprise a U-cup seal including a closed end, and the first piston seal and the second piston seal are arranged such that the closed ends of the U-cup seals are directed towards one another.

According to one or more embodiments of the present disclosure, the piston defines a first annular groove and a second annular groove, where the first piston seal seats within the first annular groove and the second piston seal seats within the second annular groove.

According to one or more embodiments of the present disclosure, an oral irrigator is disclosed. The oral irrigator includes a tip, a housing coupled to the tip and defining a housing cavity, a reservoir in fluid communication with the tip, and a pump assembly positioned within the housing and configured to pump fluid from the reservoir to the tip. The pump assembly may include a pump wall defining a pump compartment, a pump body comprising a cap, where the pump body is configured to couple to the pump wall, and a pump seal positioned between the pump wall and the cap to seal an interface between the cap and the pump wall.

According to one or more embodiments of the present disclosure, an oral irrigator including a tip; a housing defining a housing cavity and coupled to the tip; a reservoir in fluid communication with the tip; a pump assembly positioned within the housing cavity, the pump assembly configured to pump fluid from the reservoir to the tip, the pump assembly defining a pump compartment; and a combination seal comprising at least two different types of seals that seals the pump compartment from the housing cavity.

According to one or more embodiments of the present disclosure, a method of manufacturing an oral irrigator including attaching a plurality of pump components to a chassis, aligning the chassis within a housing cavity of a housing via a pair of alignment features, and securing the chassis within the housing cavity.

According to one or more embodiments of the present disclosure, an oral irrigator including a housing and a reservoir movable relative to the housing between a first position and a second position.

According to one or more embodiments of the present disclosure, an oral irrigator is disclosed. The oral irrigator includes a reservoir, a housing, and a pump coupled to the housing and configured to pump fluid from the reservoir to a tip. The pump may include a pump chamber, a piston positioned within the pump chamber, a first piston seal positioned around the piston and configured to seal against an interior wall of the piston chamber, and a second piston seal positioned around the piston and configured to seal against the interior wall of the piston chamber. The first piston seal is arranged in a first orientation relative to the piston and the second piston seal is arranged in a second orientation, different from the first.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the oral irrigator described herein and should not be construed as a complete depiction of the scope of the oral irrigator.

FIG. 1A is a front isometric view of an oral irrigator in a use or extended position.

FIG. 1B is a rear elevation view of the oral irrigator.

FIG. 2 is a rear elevation view of the oral irrigator in a collapsed position.

FIG. 3A is a front elevation view of a housing for the oral irrigator.

FIG. 3B is a bottom elevation view of the housing.

FIG. 4 is an exploded view of the housing.

FIG. 5A is a top plan view of a housing cap for the oral irrigator.

FIG. 5B is a bottom plan view of the housing cap.

FIG. 6A is a top plan view of a housing body for the oral irrigator.

FIG. 6B is a cross-sectional view of the housing body taken along line 6B-6B in FIG. 6A.

FIG. 7A is a front isometric view of a pump assembly for the oral irrigator.

FIG. 7B is a right side elevation view of the pump assembly.

FIG. 7C is an exploded view of the pump assembly.

FIG. 8 is front isometric view of a pump body for the pump assembly.

FIG. 9A is a right side isometric view of a chassis for the oral irrigator.

FIG. 9B is a left elevation view of the chassis.

FIG. 10A is a cross-section view of the oral irrigator taken along line 10A-10A in FIG. 1A.

FIG. 10B is an enlarged view of FIG. 10A.

FIG. 10C is a cross-section view of the oral irrigator taken along line 10C-10C in FIG. 1A.

FIG. 11A is a front isometric view of an oral irrigator.

FIG. 11B is a front elevation view of the oral irrigator of FIG. 11A.

FIG. 11C is a right side elevation view of the oral irrigator of FIG. 11A.

FIG. 12 is a front elevation view of the oral irrigation of FIG. 11A, with the oral irrigator in the collapsed position.

FIG. 13 is an exploded view of the oral irrigator of FIG. 11A.

FIG. 14 is an enlarged cross-sectional view of the oral irrigator of FIG. 11A taken along line 14-14 in FIG. 11C.

FIG. 15 is an cross-sectional view of the oral irrigator of FIG. 11A taken along line 15-15 in FIG. 11B.

Embodiments of the invention and their advantages are best understood by referring to the detailed description that follows. It should be appreciated that like reference numerals are used to identify like elements illustrated in one or more of the figures.

### DETAILED DESCRIPTION

Embodiments of the present disclosure relate to an oral irrigator that may be portable, easily assembled, and/or resistant to fluid leaks into areas with fluid sensitive components. It should be noted that the features described herein may described within a single device, but any of the various features may be used separately from one another, i.e., any device may include one of the features, such as the features that enable a quick assembly, without the other features, such as the sealing assembly features.

In one example, the oral irrigator may include a pump seal assembly or combination seal that seals portions of a pump assembly to prevent water from reaching components susceptible to water damage, such as electronic components. The pump seal assembly may include multiple sealing elements that act in combination with one another to prevent fluid leaking from into a designated area, such as a housing cavity. For example, the seal assembly may include a first seal, a second seal, and a third seal, where the combination of the three seals act to ensure that fluid cannot exit a wet compartment, such as a pump compartment in fluid communication with a pump piston. In one example, the first and second seals are mechanical seals, e.g., compressible seals, such as U-cups, O-rings, and/or overmolded or flexible portions coupled to a housing. The third seal may be a chemical seal, which may be chemically or compositionally configured to repel fluid, such as a grease, or another water repelling composition. In one embodiment, the chemical seal may be positioned between the two mechanical seals, helping to seal any gaps or passages between the two seals from a dry area to the wet compartment.

In some embodiments, the wet compartment may be defined as a pump housing that encloses a portion of the pump assembly, such as a connecting arm, piston, or other drive train components. The wet compartment may be sealed in part by a cap or cover that fits over the pump housing, with at least a portion of the interface between the cover and the pump housing being scaled via a seal, e.g., a mechanical seal, that prevents fluid from leaking out of the compartment. The pump housing may define a drain that directs any accumulated fluid into a desired location, such as into a reservoir.

An outlet end of the pump assembly may also be sealed to prevent fluid from leaking into a dry area or compartment from an outlet end of the pump assembly, such as a tip connection end. In one example, a space or interface between a pump outlet and a top cover or portion of the oral irrigator housing may be sealed, such as with a mechanical seal (e.g., compressible seal such as an O-ring or U-cup). The multiple seals at different possible fluid leak locations relative to the pump assembly help to ensure functionality of electrical components and long life for the device as the electrical components may be protected from possible corrosion or destruction due to exposure to fluid.

To assist in the assembly and manufacture of the oral irrigator, in some embodiments, the oral irrigator may include a chassis that defines an anchoring point or structure for the internal components of the oral irrigator. The internal components may be coupled to the chassis and the assembled chassis may be positioned within and secured to a housing or shell. In these embodiments, the chassis and/or housing may include alignment or locating features that help to align the two components relative to each other, where the alignment and locating features may further act to secure the chassis in position relative to the housing. In this manner, connections between components and operation of select components can be tested before insertion into the housing. Further, the assembled chassis can decrease manufacturing time of the oral irrigator as individual components do not need to be separately secured to the housing. This is especially true in embodiments where the oral irrigator may be a small form factor to allow increased portability and storage and individual securing of elements may be laborious and difficult.

In some embodiments, a vent assembly, such as a vent tube, vent holes, and/or a vent cover, may define a vent pathway between the reservoir and an external environment. The vent assembly may be configured to enhance pump performance by preventing a vacuum from being defined in the reservoir during operation. In other words, the pump may be configured to generate a suction force to pull fluid from the reservoir into the pump, but the flow of air between the reservoir and the external environment via the vent assembly helps to prevent a complete vacuum from occurring. This may help to increase efficiency and longevity of the pump.

In embodiments where the oral irrigator may transition between collapsed and extended configurations, a hose spring may be coupled to the hose to help the hose transition between the configurations. More specifically, the hose spring may be configured to bias the hose in an extended position, such that the hose may be more likely to deploy or expand without bends or kinks that could reduce fluid flow through the hose.

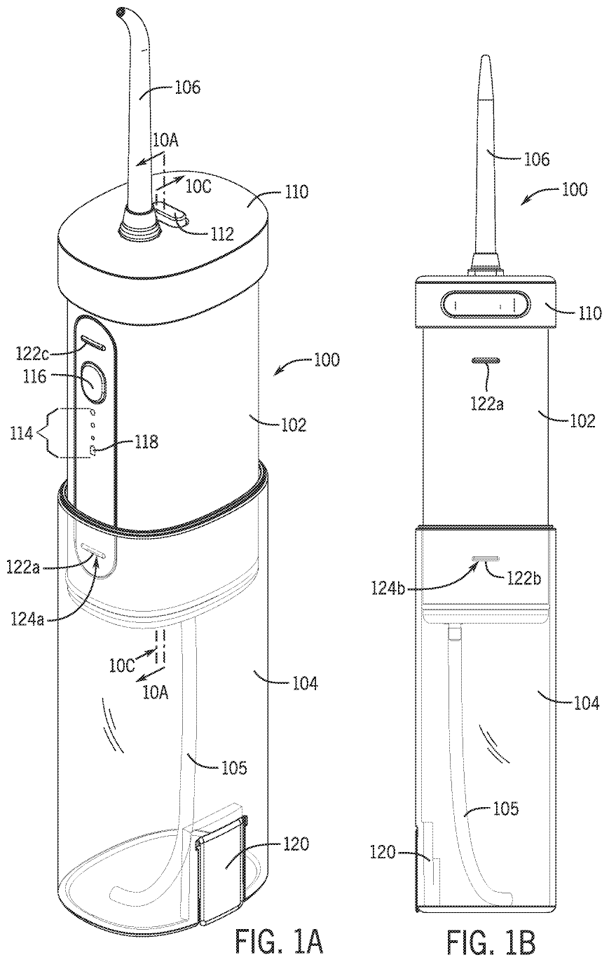

FIGS. 1A and 1B illustrate isometric and rear elevation views, respectively, of an oral irrigator in accordance with embodiments of the present disclosure. The oral irrigator 100 is configured to deliver fluid pluses, such as water pulses, to a user's oral cavity. The oral irrigator 100 may include a housing 102 that houses various internal and functional components of the oral irrigator 100, such as a pump assembly.

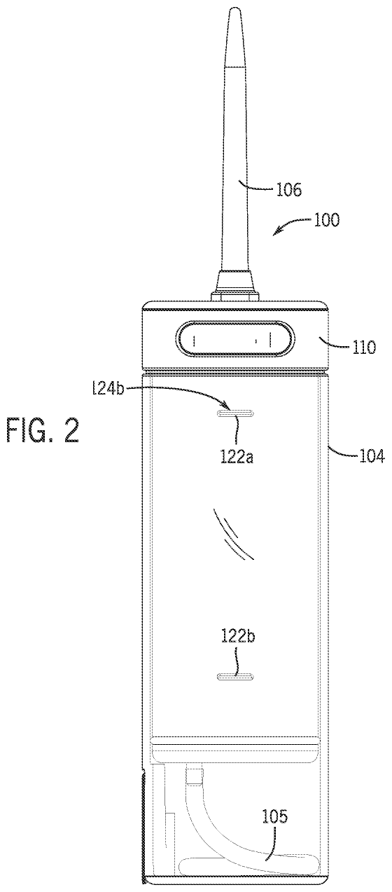

A reservoir 104 may be fluidly coupled to the housing 102 and optionally may be mechanically and removably coupled to the housing 102. In one embodiment, the reservoir 104 may also function as a storage compartment for the housing 102 and the housing may collapse into a reservoir cavity 126 (see FIG. 2). The reservoir 104 may define a reservoir cavity 126 that can hold fluid, such as water, mouth wash, or the like. In some embodiments, the oral irrigator 100 may be defined as a handheld or portable device and in these instances, the reservoir 104 may be defined in an ergonomical shape that may be easy for a user to grasp, such as an oval shape, and may have a slight taper as it transitions from a bottom end towards the top open end. However, in other embodiments, the reservoir 104 may be differently configured.

The reservoir 104 may have a top end that receives the housing 102 and a closed bottom end. In some embodiments, the reservoir 104 may also include a fill port 120 that allows a user to fill the reservoir 104 without having to disconnect the housing 102 from the top end of the reservoir 104. The fill port 120 may include a cap 144 with a seal that helps prevent water from leaking from the reservoir cavity 126.

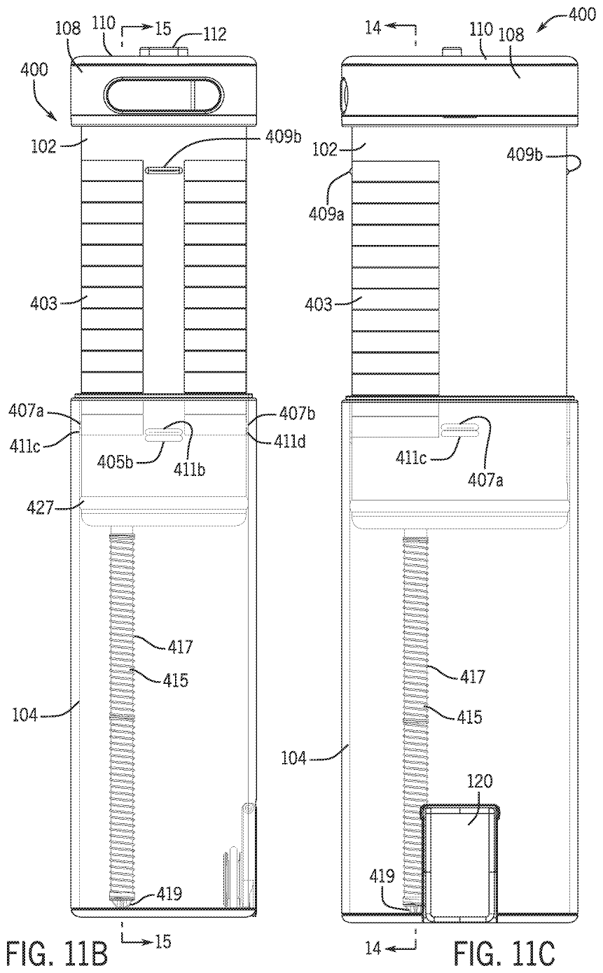

The reservoir 104 may include one or more stops 124a, 124b or reservoir engagement features, configured to engage with corresponding features on the housing 102. The reservoir engagement features or stops 124a, 124b may be positioned on opposing sides of the reservoir 104, such as on a front and back of the reservoir 104, and located below a top end of the reservoir 104. The stops 124a, 124b define the amount of housing 102 received within the reservoir cavity 126 in the extended position. In some embodiments, the stops 124a, 124b may include additional engagement features that act to limit the motion of the reservoir 104 in two directions, e.g., act as a limit for movement in a first direction (e.g., prevent further movement of the reservoir 104 upwards towards a top surface of the housing 102) and help to prevent inadvertent movement of the handle downwards into the reservoir 104). Further, the stops 124a, 124b may be positioned on either or both of the reservoir 104 and the housing 102 (sec, e.g., FIGS. 11A-11C). As discussed in more detail below, in some embodiments, the stops 124a, 124b or reservoir engagement features may be configured to generate feedback, such as tactile and/or audible, to the user as the reservoir 104 transitions into different positions.

The housing 102 supports and at least partially encloses various components for the oral irrigator 100. In some embodiments, the housing 102 may also function as a handle for the oral irrigator 100 and a tip 106, which may be a jet tip or other accessory (e.g., brush, tongue cleaner, or the like) may be coupled to a top end of the housing 102. The tip 106 may be removable relative to the housing 102 to allow a user to switch out the tip (e.g., to change accessories or tip types or to change to a different user's tip). In these embodiments, the oral irrigator 100 may also include a tip eject 112, which acts to selectively secure and release the tip 106 relative to the housing 102.

Further, with reference to FIGS. 1A and 1B, a hose 105 may be coupled to the housing 102 and in fluid communication with the reservoir 104. The hose 105 may help reduce the fill volume required for fluid within the reservoir 104 to enable fluid to be pumped to the tip 106. The hose 105 may be flexible, such as it may deform or bend, to accommodate a change in position of the housing 102, such as when the housing 102 is collapsed into the reservoir cavity 126 in the storage position. The hose 105 may optionally include a spring that may assist in expanding the hose 105 from a collapsed to an expanded position, e.g., bias the hose 105. For example, the hose 105 may include a spring that wraps around or is otherwise coupled to the exterior of the hose 105, see, e.g., FIGS. 11A, 12, and 13).

A seal 130 may be defined around a bottom end of the housing 102, where the seal 130 extends around a perimeter of the housing 102. The seal 130 may be configured to seal against the reservoir 104, either in the first (extended) or second (collapsed) positions of the oral irrigator 100, to help prevent fluid from escaping from the reservoir 104.

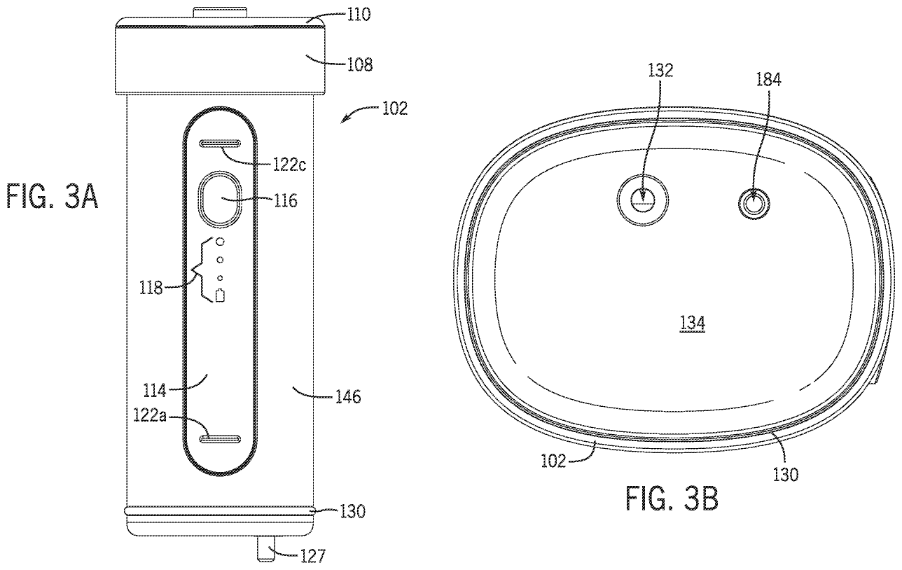

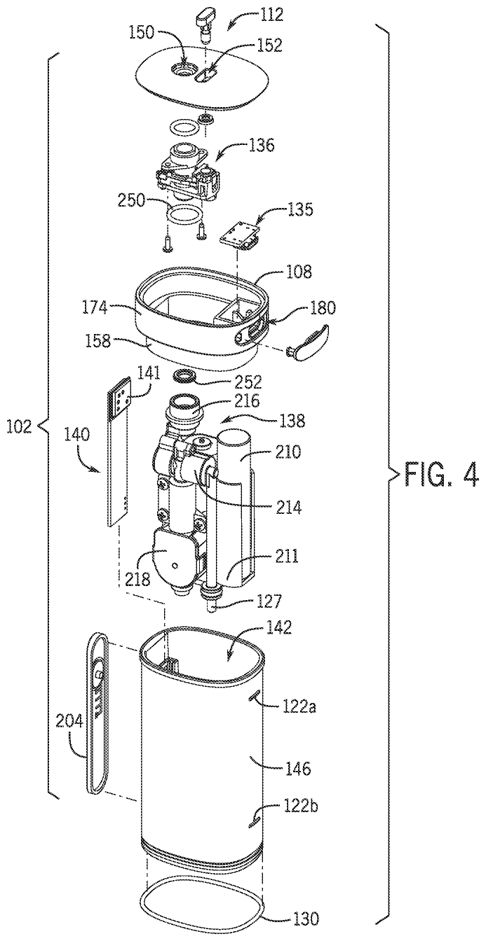

FIGS. 3A and 3B illustrate various views of the housing for the oral irrigator. FIG. 4 is an exploded view of the housing 102. The housing 102, which may define a handle or a portion of a handle, for the oral irrigator 100 may also enclose various operational components, such as a pump assembly and control board, for the oral irrigator 100.

One or more control buttons 116 may be defined on or coupled to the housing 102, which allow a user to operate the oral irrigator 100, as well as change various operational characteristics of the oral irrigator 100, e.g., increase or decrease the fluid pulse rate. Similarly, one or more lights 118, which may be light emitting diodes (LEDs), may be visible on the housing 102, where the lights 118 provide information to a user, such as a charging status, power status, operational status, or the like of the oral irrigator 100.

A cover 110 may couple to the housing 102 and form a top surface of the oral irrigator 100. The cover 110 may include one or more apertures, such as a tip aperture 150 and a button aperture 152. The tip aperture 150 is configured to receive the tip 106 therethrough and the button aperture 152 may be configured to receive a portion of a tip latch assembly 136, such as an eject assembly 112.

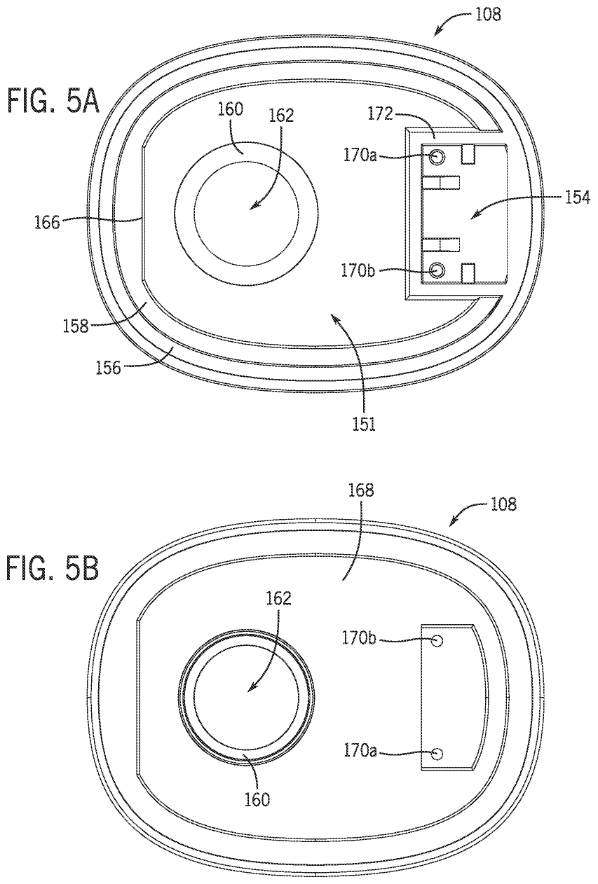

A housing cap 108 may be positioned between and coupled to the cover 110 and a housing body 146. The housing cap 108 may be configured to seal an internal compartment to the housing 102, as well as support select components of the oral irrigator 100. In one example, features of the tip latch assembly 136 may be positioned within the housing cap 108. FIGS. 5A and 5B illustrate top and bottom plan views of the housing cap 108. The housing cap 108 may include a latch compartment 151 and an electrical compartment 154, where the electrical compartment 154 may be raised above a bottom surface 168 and be separated from the latch compartment 151 via a wall 172. The electrical compartment 154 may include one or more bores 170a, 170b, which may be configured to receive wires therethrough.

A pump aperture 162 may be defined through the bottom surface 168 of the housing cap 108. The pump aperture 162 may be further defined by a flange 160 extending through the bottom surface 168 that provides additional strength to the bottom surface 168 and a seal surface for one or more seals, as will be discussed in more detail below.

The housing cap 108 may include an upper portion 174 that defines the top rim or edge of the housing cap 108 and includes an inset interior wall 156 extending around the perimeter of the upper portion 174. A lower portion 158 may extend from a bottom of the upper portion 174 and define a bottom end of the housing cap 108. The lower portion 158 may be positioned radially inwards from the upper portion 174 and may include a keying surface 166 that may have a keying or alignment shape, e.g., a shape different from the rest of the wall of the lower portion 158. For example, the lower portion 158 may be generally oval shaped and the keying surface 166 may be defined as a planar edge rather than a curved edge.

An insertion aperture 180 may be defined through an exterior wall of the housing cap 108, such as through the upper portion 174. The insertion aperture 180 may be connected to the electrical compartment 154, such as to allow components to be positioned therein during assembly of the oral irrigator 100.

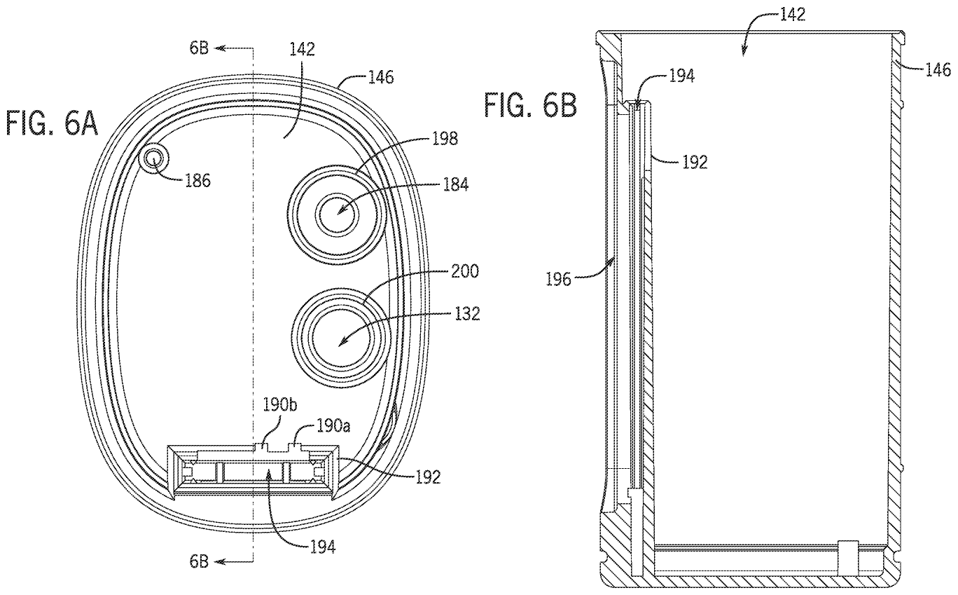

The housing 102 may also include a body 146 that defines a housing cavity 142. The body 146 may also be configured to be held by a user, such as a forming a handle portion of the oral irrigator 100, and may be shaped to be easily grasped by a user, such as in an oval shape with an overall small form factor (one that can be held in one hand by a user). Additionally, the housing 102 may include one or more grip features (see, e.g., FIG. 11A), that may be used to assist a user in gripping the housing 102. FIGS. 6A and 6B illustrate various views of the body 146. With reference to FIGS. 3, 6A, and 6B, a bottom surface 134 of the body 146 may include a drain aperture 132 and a reservoir aperture 184, both of which may be in fluid communication with the reservoir 104 when assembled. Additionally, each of the apertures 132, 184 may include sealing walls 198, 200 that surround the apertures 132, 184, e.g., a radially spaced away from, but concentric to the apertures 132, 184.

The housing 102 may include one or more alignment or locating features, such as a first alignment feature 186 and a second alignment feature 192. The alignment features 186, 192 may be configured to help align components, such as a chassis, within the housing cavity 142, as well as may be configured to help secure components, such as the chassis, to the housing 102. To that end, the alignment features 186, 192 may be defined as recessed or extended features that can interact with a similarly shaped element. In one example, the first alignment feature 186 may be defined as a post that extends upwards from a bottom surface 134 of the body 146. In this example, the alignment feature 186 may be hollow or partially recessed (e.g., female connector) and configured to mate with a male securing or locating element, such as a fastener (e.g., screw, bolt), prong, rod, etc. In another example, the first alignment feature 186 may be differently configured, such as by extending from a sidewall of the body 146, rather than the bottom surface 134, and/or may be defined as a male shaped feature configured to be positioned within a female shaped connector.

With reference again to FIG. 6A, the second alignment feature 192 may be defined as an extension from the interior wall of the body 146 and may extend partially, if not fully, along the length of the body 146. The second alignment feature 192 may be defined as a rectangular shaped structure and may include one or more ribs 190a, 190b that extend along a surface thereof. The ribs 190b, 190b may be defined on the interior most surface of the alignment feature 192 and may act to assist in securing a component in place and/or allow more refined aligning than the general shape of the second alignment feature 192.

In one embodiment, the second alignment feature 192 may define a pocket 194 or other cavity therein. The second alignment feature 192 may act as a wall that separates the pocket 194 from the housing cavity 142, which may prevent fluid from reaching components stored within the pocket 194.

With reference to FIG. 6B, a control aperture 196 may be defined on the body 146. The control aperture 196 may extend along a portion of a length of the body 146. The control aperture 196 may be configured to receive a control panel 204, therein. In one example, the control aperture 196 may be aligned with the second securing feature 192 and be in communication with the pocket 194.

A vent tube or vent assembly may also be included in the housing 102, see, e.g., FIG. 14, that may be defined along with the alignment features or the like. Alternatively, as discussed below, the vent tube may be a separate component coupled to the housing 102.

With reference to FIG. 4, the oral irrigator 100 may also include a latch assembly 136 that may act to secure and release the tip 106 from the housing 102. The latch assembly 136 may include a spring actuated latch that moves between a latched and unlatched configuration to secure the tip 106 to the housing 102. The latch assembly 136 may also include the ejection assembly 112, which may activate the latch assembly 136 to the unlatched configuration, e.g., allow a user to eject or release the tip 106. The ejection assembly 112 may include a button coupled to a spring to be biased in a first position, allowing a user to compress the button to a second position in order to eject the tip 106.

A control assembly 140 may be positioned within the housing 102 and configured to control operation of the oral irrigator 100. The control assembly 140 may include a circuit board, processing elements, one or more LEDs, or the like. The control assembly 140 may include electrical components that may be sensitive to water or fluid exposure, and so as discussed in more detail below, may be sealed from wet areas of the oral irrigator 100 to help ensure long operation of the oral irrigator 100. The control assembly 140 may also include a power source, such as one or more batteries, e.g., battery 210. The battery 210 may be electrically coupled to components of the control assembly 140, e.g., coupled to the circuit board, and may be used to provide power to the pump assembly 138.

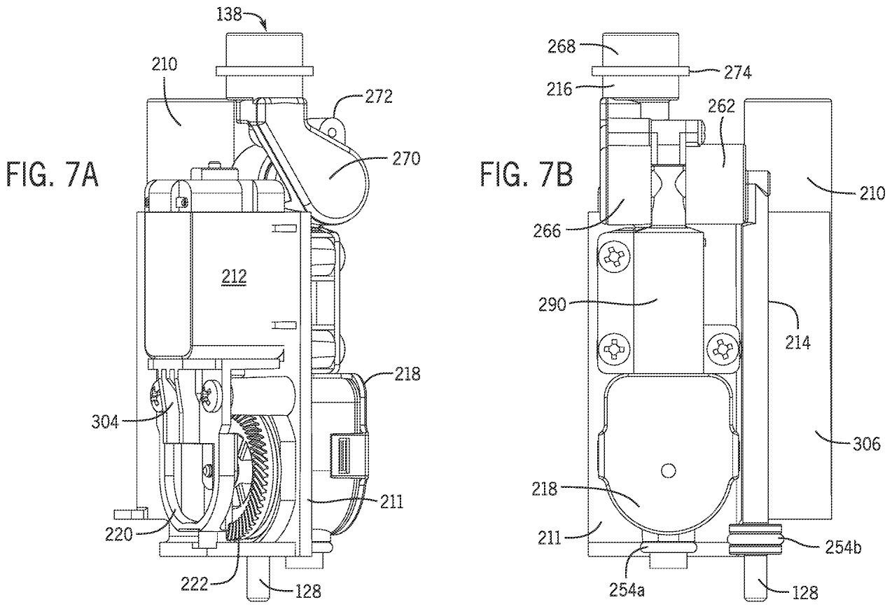

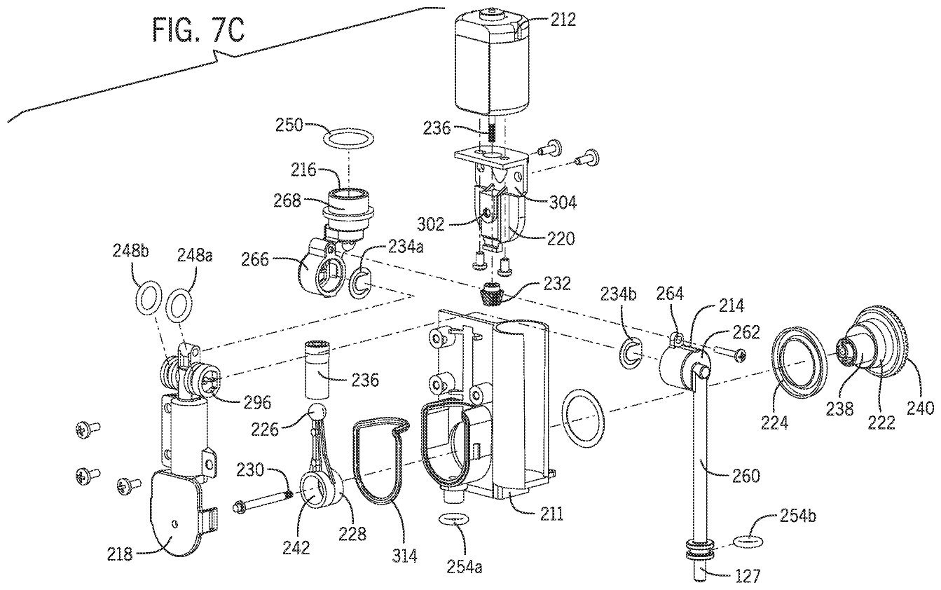

FIGS. 7A-7C illustrate various views of a pump assembly 138. The pump assembly 138 may be configured to pump fluid from the reservoir and provide it to the tip 106. As such, the pump assembly 138 may be fluidly coupled to both the reservoir 104 and the tip 106. The pump assembly 138 may include a motor 212 that may be electrically coupled to the control assembly 140. The motor 212 is configured to drive a pinon or drive gear 232 and includes a drive shaft 235. The drive gear 232 may be configured to couple to the drive shaft 235 and includes a plurality of teeth on an outer surface thereof so as to be able to mesh with another gear.

A driven gear 222 may be coupled to the drive gear 232. The driven gear 222 is configured to drive a connecting rod 228. The driven gear 222 may be shaped as a face gear and include a plurality of teeth on a front face 240 thereof. A cam portion 238 may extend from a back surface of the face 240 and define a cam surface that may be eccentric to a center axis of the face 240, which converts a rotation of the front face 240 into a reciprocating motion of the connecting rod 228.

The connecting rod 228 may be defined as a rod or other connecting element that couples to the driven gear 222. The connecting rod 228 may include a ball 226 on one end and a cam aperture 242 on the other end. The cam aperture 242 may be formed as a cylindrical aperture that is configured to couple to the driven gear 222.

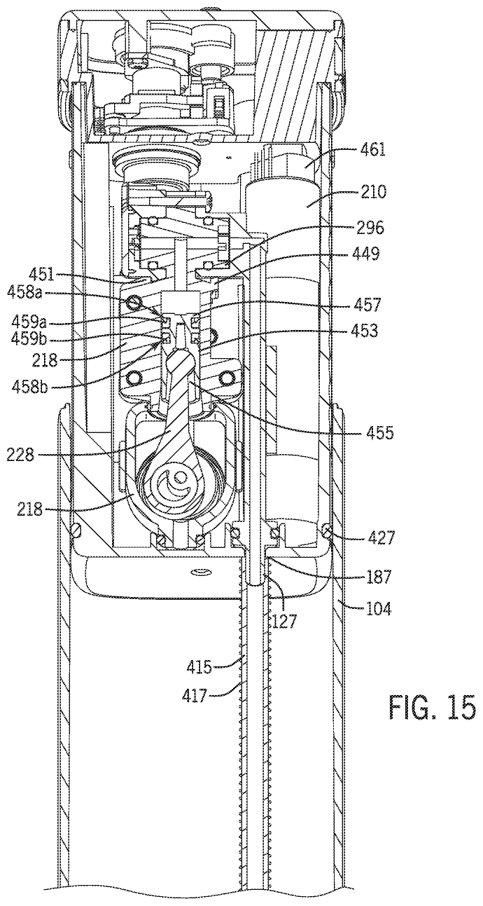

A piston 236 is configured to generate a vacuum and push force to pull fluid into the pump assembly 138 and expel fluid from the pump assembly 138. The piston 236 may be formed as a cylindrical tube that may have a slight taper after a top end, which may allow the piston 236 to seal against an interior wall of a pump body 218, but still be easily moved relative to the pump body 218. More specifically, the piston 236 may include a flexible body, such as a skirt, that flexes to seal against the interior wall of the pump body 218. However, in other embodiments, the piston 236 may include sealing elements, such as one or more flexible seals, that act to seal against the interior wall of the pump body 218, see e.g., FIG. 15.

With continued reference to FIGS. 7A-7B, the pump assembly 138 may include pump valves 234a, 234b. The pump valves 234a, 234b may be configured as one-way valves that help to control the direction of fluid flow into and out of the pump body 218. In one example, the pump valves 234a, 234b may be configured as reed valves that include a flap that allows fluid flow in one direction and seals in another direction. However, other types of valves may be used.

The pump assembly 128 may include one or more pump seals 248a, 248b, 250, 252, 254a, 254b that may be used to seal various components and connections for the pump assembly 138. In one embodiment, the pump seals 248a, 248b, 250, 252, 254a, 254b may be mechanical seals and may be formed of a compressible material that expands or deforms to seal between select elements. For example, the pump seals 248a, 248b, 250, 252, 254a, 254b may be O-rings, U-cups, or the like. In some examples, the pump seals 248a, 248b, 250, 254a, 254b may be O-rings and pump seal 252 may be configured as a U-cup, but in other configurations other types of seal configurations may be used.

An inlet connector 214 may be fluidly coupled to the reservoir 104. For example, a bottom end of the inlet connector 214 may define a hose barb 127 that extends into the reservoir cavity 126. The inlet connector 214 may include a tube 260 and an inlet valve housing 262 extending from a top end of the tube 260. The inlet valve housing 262 may define a valve cavity configured to receive one of the pump valves 234a, 234b. The valve housing 262 may also include a securing tab 264 extending from a top end that assists the inlet connector 214 in being coupled to the pump body 218.

With continued reference to FIGS. 7A-7C, an outlet connector 216 may include an outlet valve housing 266 and a tip connector 268, where the two portions may be oriented perpendicularly relative to one another, with an angled housing defining a fluid pathway extending between the two. In one example, the tip connector 268 may be oriented vertically and the valve housing 266 may be oriented horizontally relative to the housing 102, but in other configurations the outlet connector 216 may be differently configured. A sealing flange 274 may extend circumferentially around an outer surface of the tip connector 268 and be positioned below a top end of the tip connector 268. As can be appreciated, the tip connector 268 and the valve housing 266 may define an outlet fluid pathway therethrough.

A securing tab 272, which may include a fastener aperture therethrough, may extend from a portion of the outlet connector 216, such as from a top surface of the valve housing 266. With reference to FIGS. 7A and 7B, in some embodiments the outlet connector 216 may be formed as two separate components, a body and a cap 270, where the cap 270 secures to an open face of the outlet connector 216. In these configurations, the outlet connector 216 may be more easily formed, such as via injection molding, as compared to integrally formed components. However, in other embodiments, the outlet connector 216 may be formed unitarily as a single component.

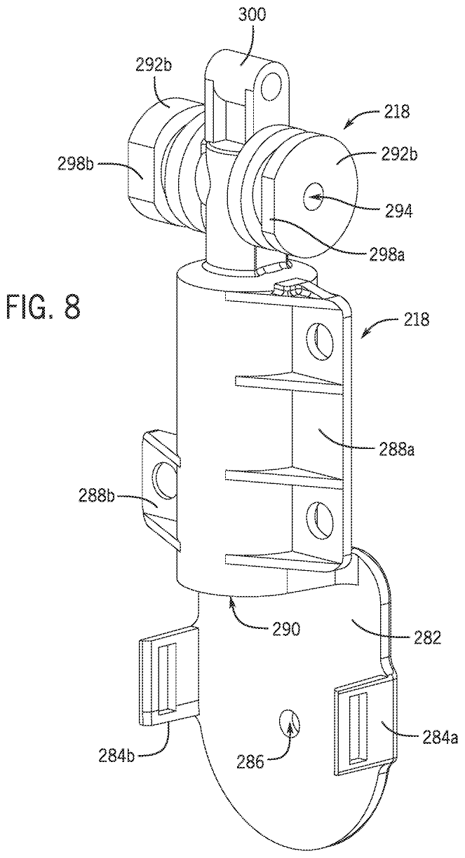

FIG. 8 illustrates an isometric view of the pump body 218. The pump body 218 may be configured to define a fluid chamber, inlet and outlet, and seal portions of the pump. In one example, the pump body 218 includes a cap 282 that may be defined on a lower end of the pump body 218. The cap 282 may be defined as a relatively planar surface with two securing tabs 284a, 284b or other securing elements extending from a sidewall thereof. The cap 282 is configured to secure over portions of the pump assembly 138 to help prevent water flow from the pump assembly 138 into the housing cavity 142. The cap 282 may include a pin support 286, which may be defined as an aperture that extends through the cap 282 or may be defined as a recessed portion recessed into an interior surface of the cap 282.

A pump housing 280 extends from the cap 282. The pump housing 280 defines a pump chamber 290 and may be defined a cylindrical compartment extending from the top end of the cap 282. The pump housing 280 optionally includes anchoring or securing features, such as brackets 288a, 288b that extend from a longitudinal sidewall of the pump housing 280. The brackets 288a, 288b may optionally include fastener apertures defined thorough.

A pump outlet housing 292a may extend from a top end of the pump housing 280. The pump outlet housing 292 may include a lateral extension fluidly coupled to the pump chamber 290. A pump outlet 294 is defined as an aperture in fluid communication with the pump chamber 290 and may be defined on a front face of the lateral extension of the outlet housing 292. An alignment surface 298a may be formed on an exterior of the outlet housing 292 to help orient the pump outlet housing 292a within the outlet connector 216.

Similarly, with continued reference to FIG. 8, a pump inlet housing 292b may extend from a top end of pump housing 280 and may be fluidly coupled to the pump chamber 290. The pump inlet housing 292b may be formed as a lateral extension from the pump housing 280, such that the pump inlet housing 292b and pump outlet housing 292a define a “t” shape with the pump housing 280. With reference to FIG. 7C, the pump inlet housing 292b may include a pump inlet 296 fluidly coupled to the pump chamber 290. The pump inlet housing 292b may also include an alignment surface 298b, which may be defined as a flat edge, to assist in aligning the pump inlet housing 292b with the inlet connector 214. With reference again to FIG. 8, a securing tab 300 forms a top end of the pump body 218 and may include a fastening aperture therethrough.

The pump body 218 may also include one or more detents (see, e.g., FIG. 15) that help to ensure tight connections between the pump body 218 and the inlet and outlet connectors coupled thereto.

With reference again to FIG. 7A-7C, a motor support 220 may assist in securing portions of the driven gear 222 relative to the pump body 218. The motor support 220 may include a pin support 302, which may be defined as an aperture or a recess within the motor support 220.

Additionally, the motor support 220 may include a bracket 304, which may be an “L” shaped or corner bracket that includes a top horizontal portion and a vertical portion, with optional fastening apertures defined therethrough.

A gear pin 230 may define a rotational axis for the driven gear 222, as well as support the driven gear 222. The gear pin 230 may optionally include threads or other securing elements on either end to help secure the gear pin 230 in place and prevent it from rotating.

A gear seal 224 or pump seal may seal against components of the pump assembly 138 to prevent fluid from leaking from a wet area (e.g., pump compartment or chamber) into the housing cavity 142. In one example, the gear seal 224 may define one of a mechanical seal for the oral irrigator 100 and pump assembly 138. The gear seal 224 may be formed of a compressible material, such as rubber, that deforms to fill gaps. In one example, the gear seal 224 may be defined as a U-cup seal, but in other configurations may be an O-ring or formed as an overmolded rubber or compressible component.

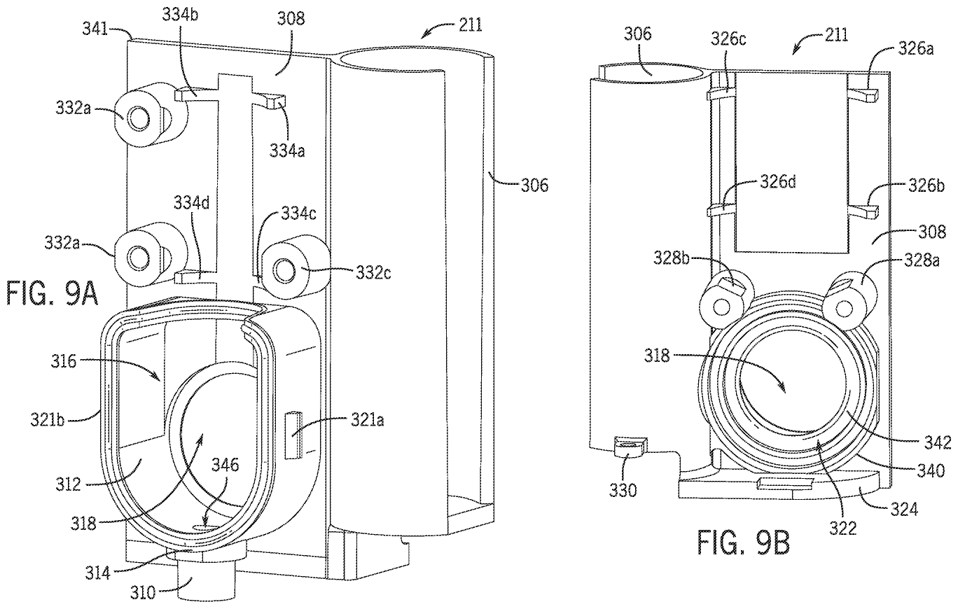

FIGS. 9A and 9B illustrate various views of a chassis 211 that may support various components of the pump assembly 138 and other internal components of the oral irrigator 100. The chassis 211 may be configured to allow multiple or all the internal components received within the housing compartment or housing cavity 142 to be secured thereto. In one example, the components may be secured to the chassis 211 before the chassis 211 is positioned within the housing 102, which may increase the case and speed of assembly. The chassis 211 may include a main support bracket 308 or frame that may include feature specific anchoring structures coupled thereto. For example, a plurality of pump support prongs 334a, 334b, 334c, 334d may extend from a first surface of the main support bracket 308. In one example, the pump support prongs 334a, 334b, 334c 334d may be aligned in opposing pairs at aligned locations on the bracket 308, e.g., a first pair of prongs 334a, 334b may be positioned at a first vertical location and spaced laterally apart one another and a second pair of prongs 334c, 334d may be positioned at a second vertical location and spaced part laterally from one another. Similarly, motor support prongs 326a, 326b, 326c, 326d may be defined on a second surface of the main support bracket 308. Optionally, a recess may be formed between the motor support prongs 326a, 326b, 326c, 326d to receive a portion of the motor 212.

A battery clamp 306 may extend from a lateral edge of the main support bracket 308 and may optionally extend longitudinally along a substantial portion of the lateral edge. The battery clamp 306 may be defend as a “C” shaped clamp and may include a bottom wall or floor to support an of the battery or may have two open ends as may be desired.

An opposite lateral edge of the main support bracket 308 may define a locating or alignment feature 341. In this example, a thickness of the main support bracket 308 may be configured to fit within the alignment ribs 190a, 190b. In this manner, features extending from the major or first and second surfaces of the main support bracket 308 may be set back from the edge, such that the chassis 211 can slide through the ribs 190a, 190b along its entire length, without contacting other mounted to or formed with the chassis 211.

Fastening posts 328a, 328b, 332a, 332b, 322c, 322d may be defined at various locations on the main support bracket 308. The fastening posts 328a, 328b, 332a, 332b, 322c, 322d may include apertures therethrough and be configured to mate with corresponding securing brackets or other features to secure elements to the chassis 211, e.g., couple to the pump body 218.

With reference to FIG. 9B, a gear compartment 322 may be defined by one more cylindrical bosses 340 extending outwards from the main support bracket 308. The gear compartment 322 may be fluidly coupled to a gear aperture 318 that extends through the main support bracket 308. A gear seal 342, which may be defined as a mechanical seal, may be formed or coupled within the gear compartment 322, such as on an interior wall of the cylindrical boss 340 defining the gear aperture 318. In one example, the gear seal 342 is a compressible material, such as rubber, and optionally may be overmolded to the interior wall, forming an integrated seal structure on the chassis 211.

A bottom wall 324 may extend laterally outwards at a bottom end of the main support bracket 308 and may extend beneath the cylindrical boss 320 defining the gear compartment 322.

A locating or alignment feature 330 may be included on the chassis 211. The alignment feature 330 may be configured to interact with a similar feature within the housing 102 and can both align and optionally secure the chassis 211 within the housing 102. In one example, the alignment feature 330 is formed as a tab or bracket that extends from the chassis 211, e.g., extends from a sidewall of the battery clamp 306. The alignment feature 330 may be positioned towards a bottom end of the chassis 211, which may allow the chassis 211 to be secured at its bottom end to the housing 102. However, in other examples, the alignment feature 330 may be positioned at different locations relative to the chassis 211, e.g., at a middle or top end. Further, the alignment feature 330 is shown as a female or receiving aperture, but in other embodiments, the alignment feature 330 may include male connection features, e.g., be formed with a post or other extending element that is received within the corresponding alignment feature within the housing 102.

With reference to FIG. 9A, a pump compartment 316 may be formed by a pump wall 312 that extends from the main support bracket 308. The pump compartment 316 may be defined on an opposite side of the main support bracket 308 from the gear compartment 322 but may be partially aligned therewith. The gear aperture 318 may extend through and open into the pump compartment 316. The pump wall 312 may be shaped to receive features of the pump assembly 138 and form a portion of the pump body. In one example, the pump wall 312 may be generally U shaped or otherwise have a concave bottom wall with two lateral walls that extend upwards from either side. A top end of the pump wall 312 may include a slot or cutout that allows pump components, e.g., connecting arm 228, to extend therethrough.

A pump seal 314 may be positioned along an outer edge of the pump wall 312 and may extend along the entire outer edge or periphery of the pump wall 312. In one example, the pump seal 314 may be a mechanical seal and be configured to expand within a gap between two components, e.g., between the pump wall 312 and the pump body 218, to seal the gap or interface. The pump seal 314 may be a compressible material and in one example may be defined as an overmolded seal secured to and formed with the pump wall 312. In these embodiments, the assembly may be easier as the seal 314 may not move as it is be positioned on the pump wall 312.

Securing tabs 321a, 321b may extend from an external side of the pump wall 312, which may assist in securing the pump body 218 to the pump wall 312 and chassis 211. Additionally, as shown in FIG. 9A, a drain port 310 may extend from the bottom end of the pump wall 312, e.g., at a lowest point in the pump wall 312, such as the bottom of the U structure. A drain aperture 346 may be defined through the pump wall 312, fluidly coupling the drain port 310 with the pump compartment 316.

With reference to FIGS. 4, 7C, and 10A-10C, the assembly of the oral irrigator 100 will now be discussed. As mentioned, the chassis 211 is configured to support components received within the housing cavity 142 and as such, components configured to be received within the main housing cavity 142 may be secured to the chassis 211 and then inserted into the housing body 146. In one example, the pump assembly 138 may be coupled together. For example, the piston 236 may be inserted on to the ball 226 of the connecting rod 228 such that the piston 236 moves with the connecting rod 228. The cam aperture 242 of the connecting rod 228 may be inserted over the cam portion 238 of the driven gear 222. The gear seal 224, which may be a first mechanical seal, may then be inserted over the body of the driven gear 222 between the front face 240 and the cam portion 238. In some embodiments, a chemical or composition seal 360 may be applied to a first surface of the gear seal 224, such as a surface facing towards the cam portion 238 of the driven gear 222, e.g., a surface facing towards a wet compartment of the oral pump assembly 138. Optionally, the chemical seal 360, which may be a water or other fluid repellant, such as a silicone or other grease, may also be applied to an exposed surface of the gear seal 342 formed within the gear compartment 322. In both embodiments, the chemical seal 360 may be positioned between the gear seal 224 and gear seal 342 to repel fluid from the gap or space between the two seals 224, 342.

The driven gear 222 may be inserted into the gear compartment 322, e.g., within the cylindrical boss 340 on the chassis 211. The driven gear 222 is inserted into the gear compartment 322 such that the cam portion 238 extends through the gear aperture 318 and the outer surface of the driven gear 222 engages the gear seal 342 formed on the interior wall of the chassis 211 forming the gear aperture 318. In this configuration, the gear seal 342 may act as a second mechanical seal for the pump assembly 138. Additionally, the two mechanical seals, e.g., gear seal 224 and gear seal 342, act to trap or contain, chemical seal 360 between the two. In this manner, the seals 224, 342, 360 may define a combination seal that acts as a three layer seal to prevent water or other fluid from leaking into or out of the pump compartment 316 via the gear aperture 318.

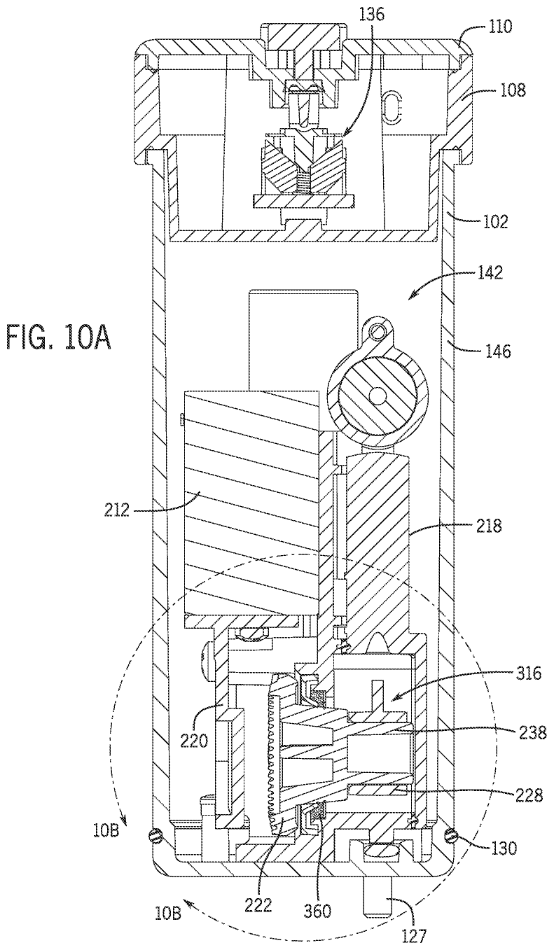

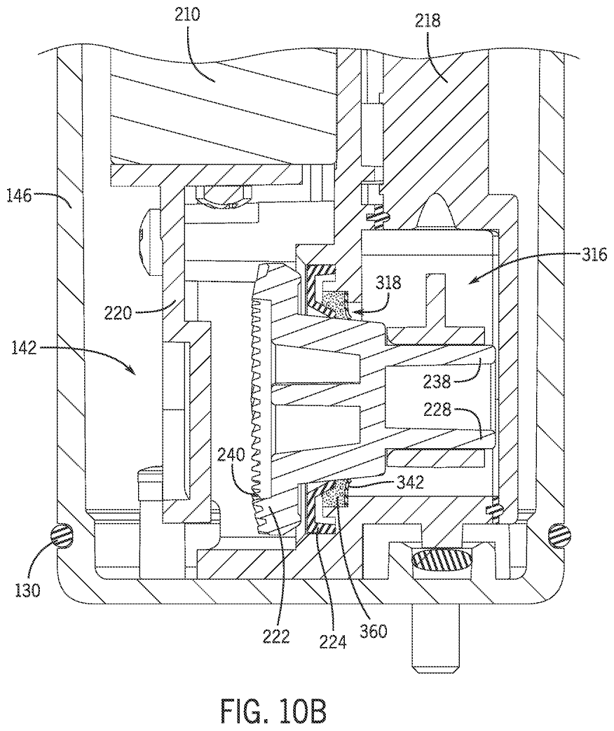

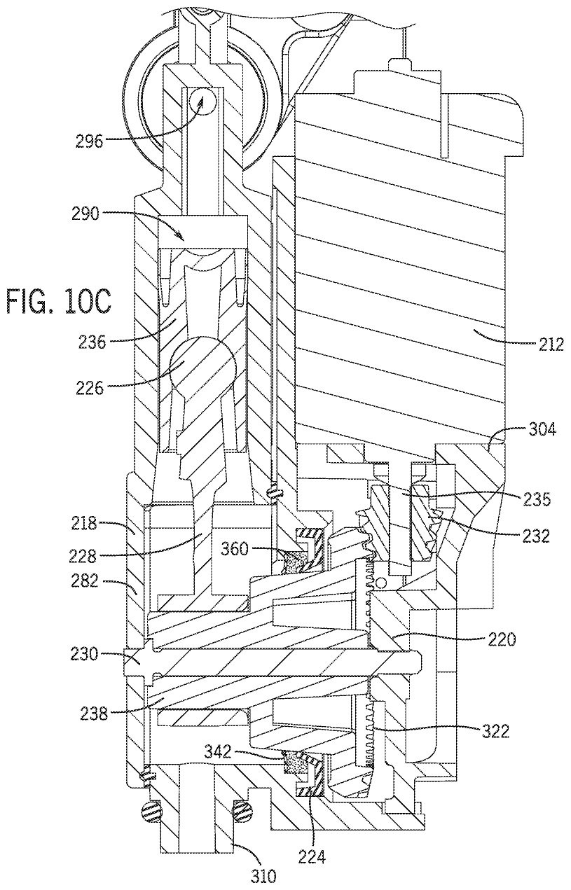

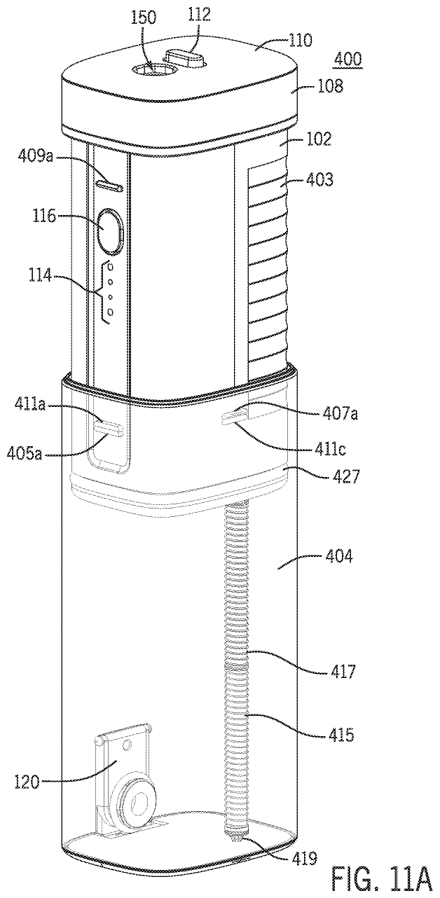

Gear pin 230 is inserted into a center of the driven gear 222 and extends into the pump compartment 316 via the gear aperture 318. With reference to FIG. 9A and FIG. 10C, the piston 236 and connecting rod 228 are positioned within the pump chamber 290 of the pump housing 280. The pump support prongs 334a, 334b, 334c, 334d engage the outer surface of pump body 218 at the pump chamber 290 to help locate the pump body 218 on the chassis 211. The pump body 218 may be secured to the chassis 211. For example, the gear pin 230 may be inserted into the pin support 286 and the securing tabs 284a, 284b may be coupled to the securing tabs 321a, 321b on the pump wall 312. Fastening posts 332a, 332b, 332c are aligned with brackets 288a, 288b, 288c of the chassis 211 and fasteners may be inserted into fastening apertures and into the fastening posts 332a, 332b, 332c coupling the pump body 218 to the main support bracket 308 of the chassis 211. As the fasteners are secured and tightened, the pump body 218 is compressed against the pump seal 314 on the top edge of the pump wall 312. Specifically, the interior surface of the cap 282 engages the pump seal 314 exerting a compression force, which causes the pump seal 314 to expand between any space between the cap 282 and the pump wall 312, sealing any gaps to prevent fluid or debris from exiting the pump compartment 316 at the pump body 218 interface with the chassis 211.

With reference to FIG. 7A and 10A-10C, the gear pin 230 may be received through the pin support 302 on the motor support 220 (in some instances, the gear pin 230 may be coupled to the motor support 220 before being inserted into the pin support 286 on the pump body 218, depending on how the gear pin 230 may be secured in place, e.g., where an enlarged end may be oriented). The motor support 220 may be positioned on the bottom wall 324 of the chassis 211 with the bracket 304 facing upwards towards a top end of the chassis 211. Drive gear 323 is positioned on a bottom facing surface of the bracket 304 of the motor support 220 and the drive shaft 235 of the motor is inserted into the drive gear 323 through a drive aperture in the bracket 304 as the motor 212 is seated on the top surface of the bracket 304. Fastening apertures on the motor support 220 may be aligned with fastening posts 328a, 328 and fasteners, such as screws, may be inserted therein, securing the motor support 220 to the chassis 211. The motor support prongs 326a, 326b, 326c, 326d help align the motor 212 on the chassis 211 and engage the outer surface of the motor 212 as it is positioned on the chassis 211.

With reference to FIGS. 7A, 7C, and 8, the inlet connector 214 may be coupled to the pump body 218. For example, a pump valve 234b is positioned in the pump inlet housing 292 over the pump inlet 296. A seal 248a may be received around the pump inlet housing 292 and the inlet valve housing 262 of the inlet connector 214 is inserted around the pump inlet housing 292, fluidly connecting the pump inlet 296 to the tube 260 and hose barb 127. A seal 254a may be positioned around the tube 260, such as between two flanges towards the bottom end of the tube 260 adjacent the hose barb 127.

The outlet connector 216 may be coupled to the other side of the pump body 218. For example, pump valve 234 may be inserted into valve housing 266 of the outlet connector 216 and a seal 248a may be positioned around the pump outlet housing 292a. The valve housing 266 is positioned around the pump outlet housing 292, fluidly coupling the pump outlet 294 with the tip connector 268 of the outlet connector 216. With reference to FIG. 7B, the outlet connector 216, pump body 218, and inlet connector 214 may be secured together as the securing tab 300 of the pump body 218 is aligned with securing tab 272 of the outlet connector 216 and securing tab 264 of the inlet connector 214, respectively, and a fastener may be interested through a fastening aperture defined through all three. Pump seal 250 is received around the tip connector 268 of the outlet connector 216 and pump seal 252 may be positioned within the tip connector 216. In one example, the outer pump seal 250 may be positioned above the sealing flange 274 and the interior pump seal 252 may be positioned internally within the tip connector 216 at a location that generally corresponds to the sealing flange 274.

With reference to FIG. 7B and 9A, the battery 210 is inserted into the battery clamp 306 on the chassis 211.

With reference to FIGS. 4 and 6A, the control assembly 140 may be received within the pocket 194 defined in the body 146 of the housing 102. For example, the control assembly 140 may include a circuit board that slides into the pocket 194 and optionally may include a seal, such as a grommet 141 (see FIG. 4), that sits on a top edge of the second alignment feature 192 defining the pocket 194. The seal 141 seals the wire connections (not shown) that may extend between the battery 210 and the control assembly 140, electrically coupling the two components. The control panel 204 may be coupled to the body 146 to at least partially cover the control assembly 140.

The assembled chassis 211, which may include various internal components of the oral irrigator 100, including the pump assembly 138, may then be inserted into the housing cavity 142. The alignment features 192, 341 of the housing 102 and chassis 211, respectively, may be oriented to align the chassis 211 in the proper orientation relative to the housing 102. For example, the alignment feature 341 of the chassis may be positioned between the alignment ribs 190a, 190b on the alignment feature 192 of the housing 102 and can be slid into position. Alignment feature 186 may be aligned or located with alignment feature 330 on the bottom of the chassis 211, so as to align secure the chassis 211 in position. For example, the alignment feature 330 may be secured to the alignment feature 186 of the housing 102, such as by extending into the alignment feature 186 or a fastener being used to securely couple the two alignment features 196, 330 together. When aligned, the hose barb 127 extends through the reservoir aperture 184, with the seal 254a scaling against wall 200 and drain port 310 extending through drain aperture 132. Optionally seal 254b may be positioned around the drain port 310 and seal against the surrounding wall 198 when the drain port 310 is positioned within or adjacent to the drain aperture 132. In this manner, the internal housing cavity 142 may be sealed from fluid leaking form either the reservoir aperture 184 or the drain aperture 132. In some embodiments, the drain port 310 may function as an alignment feature during assembly of the oral irrigator. For example, the drain port 310 may engage the sealing wall 200 or boss of the drain reservoir 132 that extends upwards from the bottom wall of the housing 102 to ensure the chassis 211 is positioned correctly within the housing 102.

In one example, substantially all of the components of the oral irrigator received within the housing cavity 142 are secured to the chassis 211. This allows the internal oral irrigator 100 components, such as the pump assembly 138, to be assembled outside of the housing body 146 and inserted into the housing body 146 via a single insertion, e.g., by positioning the chassis 211 within the housing body 146. This helps to prevent an assembler from having to locate and secure multiple components within the housing body 146, rather aligning and securing the chassis 211 will act to align and secure the pump assembly 138 and other internal components to the housing 102.

With reference to FIGS. 4 and 5B, the housing cap 108 may be positioned on top of and secured to the body 146. For example, the lower portion 158 may be inserted into the housing cavity 142 and the tip connector 268 of the outlet connector 216 is inserted into the pump aperture 162 of the housing cap 108. Pump seal 250 (see FIG. 4) may seal against the flange 160, preventing fluid from leaking through the pump aperture 162 into the housing cavity 142. The keying surface 166 of the housing cap 108 may help to locate or align the housing cap 108 on the housing body 146. For example, the keying surface 166 may be configured to align with the alignment feature 192, providing a visual indicator to an assembler of how to position the housing cap 108 on the body 146.

The tip latch assembly 136 may be coupled to the tip connector 268 of the outlet connector 216 and may be positioned within the latch compartment 151 of the housing cap 108. An optional sub control assembly 135 may be positioned within the electrical compartment 154, with optional wires extending through bores 170a, 170b to electrically couple the sub-control assembly 135 to the battery 210 and/or control assembly 140.

The cover 110 may be positioned over and on top of the housing cap 108, covering the latch compartment 151 and the electrical compartment 154. The tip aperture 150 may be aligned with the tip latch assembly 136, such that when the tip 106 is received within the tip aperture 150 the tip may be fluidly coupled to the tip latch assembly 136 and the tip connector 268 of the outlet connector 216. The eject assembly 112 may be partially received within the button aperture 152, such that a user can access the eject assembly 112 (e.g., a button) to actuate the tip latch assembly 136, e.g., to release a tip 106 from the tip latch assembly 136. The cover 110 may then be welded or otherwise secured to the housing cap 108. Additionally, the housing body 146 may be secured to the housing cap 108, optionally via welding, which prevents fluid from leaking in through the interface between the two components.

To use the oral irrigator 100, the user may open the port 120 to fill the reservoir 104 with fluid, such as water. Once filled, the user may close the port 120 and insert the tip 106 into the tip aperture 150. The tip 106 engages the tip latch assembly 136, securing the tip 106 to the housing 102 and fluidly coupling the tip 106 to the outlet connector 216. The user may then activate the pump assembly 138, such as by pressing the control button 116, which provides power to the motor 212 from the battery 210.

As the motor 212 is powered, the motor 212 rotates drive shaft 235, which in turn rotates drive gear 232. The drive gear 232 engages with the teeth on the front face 240 of the driven gear 222, causing the driven gear 222 to rotate about gear pin 230. This rotation causes the cam portion 238 to drive the connecting arm 228 in an oscillating motion. The connecting arm 228 alternatingly pushes and pulls the piston 236 within the pump chamber 290. During a down stroke, the connecting arm 228 pulls the piston 236 downwards within the pump chamber 290 creating a vacuum. The vacuum force pulls fluid in from the reservoir 104 via the hose 105, which then flows into hose barb 127 and into tube 260 of the inlet connector 214. The fluid force opens the valve 234b fluidly connecting the tube 260 to the pump inlet 296. The fluid then travels into the pump chamber 290 via the pump inlet 296. On an upward stroke, the connecting arm 228 pushes the piston 236 upwards in the pump chamber 290, pushing the fluid out of the pump chamber 290 and into the pump outlet 294. The fluid force opens the valve 234a and the fluid then enters into the outlet connector 216. From the outlet connector 216, the fluid travels to the tip 106 and is expelled, such as into a user's oral cavity.

When irrigating is complete, the user can turn off the motor 212 via the control button 116, which disconnects the motor 212 from the battery 210. With the reservoir 104 empty or mostly empty, the user can transition the oral irrigator 100 into a storage position. For example, the user can press on the top cover 110, exerting a downward force that causes the housing 102 to move downwards and into the reservoir 104, e.g., the force causes the lower catches 122b, 122d disengage from the stops 124a, 124b on the reservoir 104, allowing the housing 102 to move. The housing 102 continues to move into the reservoir 104 until the upper catches 122a, 122c catch the stops 124a, 124b on the reservoir 104. In the collapsed or storage position, the oral irrigator 100 takes up less volume and can be more easily stored and is more portable than conventional oral irrigators and oral health devices.

Notably, any fluid that drips out of the pump compartment 290, 316 during operation of the pump assembly 138 may be prevented by the combination seal from exiting out of the gear aperture 318 in the chassis 211. Rather, any fluid that accumulates within the pump compartment 290, 316 may be encouraged by the shape of the pump wall 312 to flow into the drain port 310 and drain into the reservoir 104. Additionally, the pump seal 314 prevents fluid from the pump compartment 290, 316 from escaping via the interface between the pump body 218 and the chassis 211. In this manner, the housing cavity 142 may define a dry compartment or area sealed from the wet area of the pump compartment 290, 316. Further, the pump seals 250, 252 that couple to the outlet connector 216 help to prevent fluid from leaking into the housing cavity 142 via the tip latch assembly or tip connector 268. Rather, all fluid is forced to stay within the outlet connector 216 and wet area of the pump assembly. The welded connections between the housing cap 108, housing cover 110, and housing body 146 prevent external fluid, such as from the environment, from entering into the housing cavity 142 ensuring that the housing cavity 142 remains dry, and electronic components, such as the motor 212, battery 210, and circuit assembly 240 are not exposed to fluid.

FIGS. 11A-15 illustrate various views of an oral irrigator 400, which may be substantially similar to oral irrigator 100. More specifically, any elements not specifically described in oral irrigator 400 may be the same as those described with respect to oral irrigator 100. Further, any features described with respect to oral irrigator 400 may be incorporated in oral irrigator 100 and the discussion of any implementation or component with respect to oral irrigation 100 or oral irrigator 400 is meant as illustrative only. Similar to the oral irrigator 100, oral irrigator 400 may transition between two configurations, e.g., an extended or operational configuration and a collapsed or storage configuration.

With reference to FIGS. 11A-11C, the oral irrigator 400 may include a grip 403 or multiple grip features formed on a portion of the housing 102. In one example, the grip 403 may include a plurality of raised protrusions alternating with recessed areas that may define seating areas for portions of a user's hand, e.g., fingers, to assist a user in griping and manipulating the oral irrigator 400, especially in instances where the housing 102 may be wet or include debris. In one example, the grip 403 includes two portions, e.g., a right and left portion, that extend from the left and right sides, respectively, of the housing 102 towards a back surface thereof. The grip 403 may extend along the entire length or a portion of the length of the housing 102. In many implementations, the grip 403 may be formed unitarily with the housing 102, but in other implementations, the grip 403 may include another material, such as a rubber or silicon, that may enhance a frictional engagement with the housing 102.

With continued reference to FIGS. 11A-11C, one or more engagement features may be included on the housing 102 for the oral irrigator 400. Similar to the stops 124a, 124b, the engagement features 405a, 405b, 407a, 407b, 409a, 409b may be defined as protrusions that extend outwards from the housing 102. The engagement features 405a, 405b, 407a, 407b, 409a, 409b may act as stops and/or feedback elements as the oral irrigator 400 transitions between collapsed and expanded positions. For example, the engagement features 405a, 405b, 407a, 407b, 409a, 409b may engage with similar features on the reservoir 104 to provide feedback (e.g., tactile and/or audible) to the user and/or act as a stop preventing inadvertent movement of the housing 102 relative to the reservoir 104.

In some embodiments, the engagement features 405a, 405b, 407a, 407b, 409a, 409b may be defined in pairs that are aligned at the same location along a longitudinal axis of the housing 102 (e.g., same distance from a top or bottom of the housing 102). For example, a first set of engagement features 405a, 405b may be defined on the front and rear surfaces of the housing 102, a second set of engagement features 407a, 407b may be defined on the left and right sides of the housing 102, and a third set of engagement features 409a, 409b may be defined on the front and rear surfaces of the housing 102, but spaced apart from the first set.

In one example, the first set of engagement features 405a, 405b may be offset at a different vertical location from the second set of engagement features 407a, 407b. For example, the first set of engagement features 405a, 405b may be positioned lower vertically relative to the second set of engagement features 407a, 407b, e.g., closer towards a bottom end of the housing 102. The offset vertical positioning of the first and second sets of engagement features 405a, 405b, 407a, 407b acts to help prevent inadvertent transitioning and/or decoupling between collapsed and expanded configurations. More specifically, the first set of engagement features 405a, 405b may help to ensure the reservoir 104 is in the correct position relative to the housing 102 and help prevent the reservoir 104 from inadvertently sliding off of the housing 102 during use. The second set of engagement features 407a, 407b may be staggered or offset from the first set and positioned above corresponding reservoir features to help prevent inadvertent collapse of the housing 102 into the reservoir 104.

The third set of engagement features 409a, 409b may be aligned with the first set of engagement features 405a, 405b but be positioned at a different vertical location, e.g., closer to a top end of the housing 102 as compared to the first set of engagement features 405a, 405b. In other words, the third set of engagement features 409a, 409b may be higher than the first set of engagement features 405a, 405b. The third set of engagement features 409a, 490b may be configured to assist in retaining the reservoir 104 in the collapsed position and/or provide feedback to the user (e.g., tactile and/or audible) regarding the position of the reservoir 104 relative to the housing 102.

As shown in FIGS. 11A-11C, the various engagement features 405a, 405b, 407a, 407b, 409a, 409b may be defined as protrusions or ribs that extend outwards from the outer surface of the housing 102. However, it should be noted that one or more of the engagement features 405a, 405b, 407a, 407b, 409a, 409b may be formed as recesses or grooves or otherwise define an engagement area to interact with one or more reservoir engagement features 411a, 411b, 411c, 411d of the reservoir.

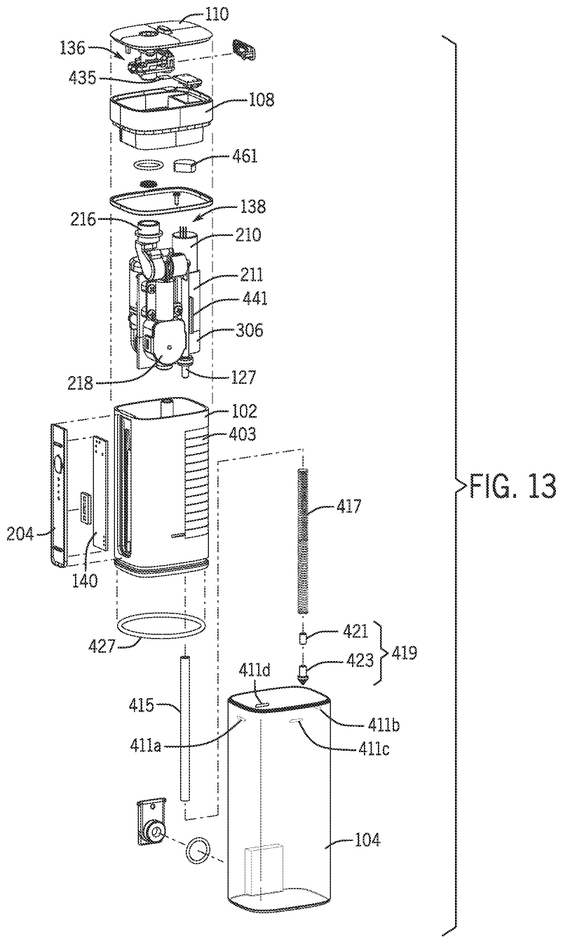

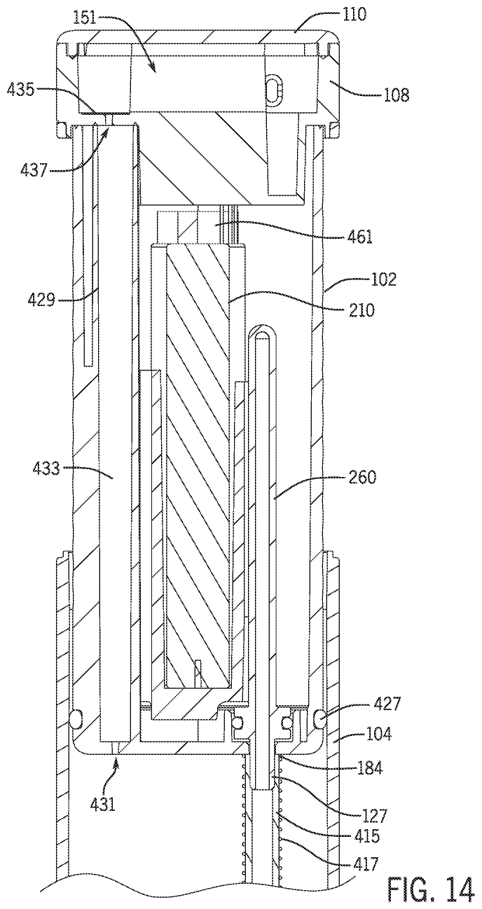

FIG. 13 illustrates an exploded view of the oral irrigator 400. With reference to FIGS. 11A, 11B, and 13, the reservoir engagement features 411a, 411b, 411c, 411d of the reservoir 104 may be defined on one or more interior surfaces of the reservoir 104 walls, e.g., the front wall, left wall, right wall, and rear wall. The reservoir engagement features 411a, 411b, 411c, 411d may be aligned so as to be at the same vertical height as one another as shown in FIG. 13. Or in other embodiments, the reservoir engagement features 411a, 411b, 411c, 411d may be offset or staggered relative to one another. In these embodiments, the housing 102 engagement features 405a, 405b, 407a, 407b may be aligned rather than offset. Also, it should be noted that although four engagement features 411a, 411b, 411c, 411d are disclosed, in other embodiments, there may be fewer or more. The reservoir engagement features 411a, 411b, 411c, 411d may be formed as protrusions that extend inwards from an interior surface of the reservoir 104, but in other embodiments may be formed as grooves, recesses, or differently configured raised portions.

With reference to FIG. 11A, in the extended configuration of the reservoir 104 relative to the housing 102, the reservoir engagement features 411a, 411b, 411c, 411d may engage with the first and second sets of engagement features, e.g., housing engagement features 405a, 405b, 407a, 407b. For example, as the user slides the reservoir 104 downwards relative to the housing 102, the first set of engagement features 405a, 405b may engage the reservoir engagement features 411a, 411b to act as stops and prevent further downward movement of the reservoir 104. The second pair of engagement features 407a, 407b may act as feedback for the user as the engagement features 411c, 411d engage them and travel over the top surface thereof, e.g., generate a click or other sound. Once fully extended, the first set of engagement features 405a, 405b help to ensure that the reservoir 104 does not inadvertently slide off the housing 102, even in instances where the reservoir 104 is filled with fluid.

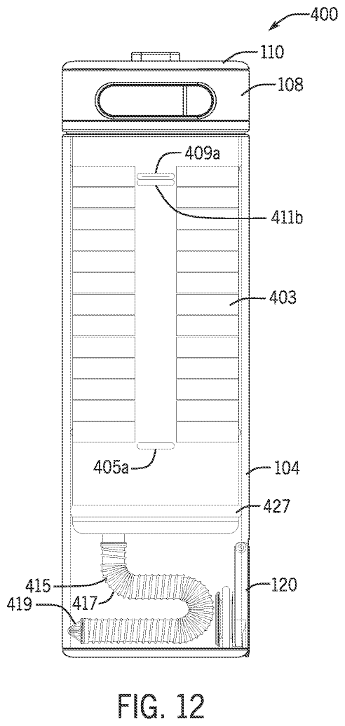

With reference to FIG. 12, once the user is done irrigating or otherwise wishes to collapse the irrigator 400, the user applies a force to the reservoir 104 and slides the reservoir 104 and reservoir engagement features 411a, 411b over the first engagement features 405a, 405b. The user can continue to move the reservoir 104 until engaging the third set of engagement features 409a, 409b. The reservoir engagement features 411a, 411b, slide over the third set of engagement features 409a, 490b and then seat on the top surface thereof. This seated positioning helps to prevent the reservoir 104 from inadvertently sliding off of the housing 102, e.g., accidentally transiting to the extended position.

With reference again to FIGS. 11A-13, a hose 415, which may be substantially similar to the hose 105, may be included with the oral irrigator 400. The hose 415 may be a flexible tube that fluidly connects the reservoir 104 to the housing 102 (e.g., to the pump assembly). A spring 417 or hose biasing member may be coupled to the hose 415. For example, the spring 417 may be wrapped around a portion of the hose 415, such as a bottom end, or as shown in FIG. 11A, may be wrapped around the entire or substantial length of the hose 415. The spring 417 assists the hose 415 as the oral irrigator 400 transitions between collapsed and extended positions, e.g., by biasing the hose 415 to a fully extended position. In this manner, the spring 417 helps to ensure that the hose 415 is fully open for fluid flow (e.g., helps to eliminate bends/kinks in the hose 415) to enable full fluid flow. It should be noted that although the spring 417 is shown as a separate member relative to the hose 415, in some embodiments, the spring 417 may be integrated with the hose 415.

With reference to FIG. 12, in the collapsed configuration, the hose 415 and spring 417 may be deformed, e.g., bent, to fit within the reduced volume of the reservoir 104. The spring 417 may help to prevent the hose 415 from bending or deforming at small angles, which could prevent quick and full expansion of the hose 415 and generate wear on the hose 415.

A filter 419 may also be coupled to the hose 415. The filter 419 acts to stop debris or particles from flowing into the hose 415. The filter 419 may include an anchor 421 and screen portion 423 (see FIG. 13), where the anchor 421 is received within the hose 415 and helps to secure the screen portion 423 to the hose 415. The screen portion 423 may optionally be angled, e.g., define a frustum or conical shape, which may assist in enabling fluid flow into the hose 415, such as by helping to define a space between a surface of the reservoir 104 and the bottom of the hose 415.

With continued reference to FIGS. 11A, 11B, 11C, and 13, a reservoir seal 427 may be coupled to the housing 102 to seal an interface between the housing 102 and the reservoir 104. In one example the reservoir seal 427 may be an O-ring or U-cup that defines a compressible material that expands to engage the interior surface of the reservoir 104 and the outer surface of the housing 102 to prevent fluid from the reservoir 104 from escaping the reservoir 104 around the housing 102. The reservoir seal 427 may be configured to be compress to allow movement of the reservoir 104 relative to the housing 102, but then expand and seal against the interior walls of the reservoir 104 to prevent fluid leakage.

FIG. 14 illustrates a cross-sectional view of the oral irrigator 400 taken along line 14-14 in FIG. 11C. With reference to FIGS. 13 and 14, a vent tube 429 may be included that fluidly couples the interior of the reservoir 104 to the external environment, e.g., ambient air surrounding the oral irrigator 400. In one example, the vent tube 429 may be defined as a flow passage 433 formed unitarily as a wall within the housing 102. The flow passage 433 may be fluidly coupled to the reservoir 104 by a first vent hole 431 on a first end, where the first vent hole 431 extends through the bottom surface of the housing 102, and on a second end to the latch compartment 151 via a second vent hole 437. In this manner, the vent tube 429 allows a fluid, such as air, to flow between the interior of the reservoir 104 and the latch compartment 151, which may be in fluid communication with the external environment, such as via the tip aperture 150 or button aperture 152. The vent tube 429 and corresponding vent holes 431, 437 (vent assembly) help to improve pump performance for the oral irrigator 400 by reducing the vacuum effect experienced on the reservoir 104 during a suction stroke of the pump.

In some embodiments, a vent cover 435 may be included and positioned over one or both the vent holes 431, 437. The vent cover 435 may be air permeable, but may prevent other substances, such as debris, grease, or certain other fluids, from passing therethrough. For example, the vent cover 435 may be waterproof, such as a porous polytetrafluoroethylene. In this manner, the vent cover 435 enables air flow through the vent tube 429, but prevents debris (for example) from entering into the reservoir 104.

With reference to FIGS. 13 and 14, the chassis 211 may include an alignment feature 441 that may be configured to assist in aligning and retaining the tube 260. The alignment feature 441 may be defined as a vertically oriented rib that extends parallel to a longitudinal axis of the battery clamp 306. The alignment feature 441 may be configured to orient the tube 260 relative to the reservoir aperture 184 in the housing 102. For example, as the components of the oral irrigator 400 are coupled to the chassis 211 as discussed above with respect to the oral irrigator 100, the tube 260 is seated between the pump body 218 and the alignment feature 441. Then, as the chassis 211 is inserted into the housing 102, the housing alignment features, align the chassis 211 properly, which then aligns the tube 260 with the reservoir aperture 184, helping to ensure that the hose barb 127 fits into the reservoir aperture 184.

FIG. 15 is an enlarged cross-section view of the oral irrigator 400 taken along line 15-15 in FIG. 11B. As shown in FIG. 15, retaining features, such as detents 449, 451 may be defined on the pump body 218 to help prevent leakage at different connections to the pump body 218. For example, a first detent 449 may be defined adjacent to the pump inlet 296 and a second detent 451 may be defined adjacent to the pump outlet 294. The detents 449, 451 are configured to help prevent movement of the inlet connector 214 and the outlet connector 216 relative to the pump body 218 during operation. The detents 449, 451 may be defined as lips or edges that help to define a stop or limit movement of the inlet connector 214 and outlet connector 216, helping to ensure a tight fit.

With continued reference to FIG. 15, a piston 453 is disclosed that includes a more cylindrical shape than the piston 236 for the oral irrigator 100. The piston 453 is substantially the same as piston 236 and includes a cavity 455 for receiving a portion of the connecting arm 228, e.g., for receiving the ball 226 of the connecting arm 228. The piston 453 may be configured with one or more piston seals 459a, 459b configured to seal against the interior walls of the pump chamber 290. In this manner, the piston 453 itself may not need to have a flared skirt or other portion configured to seal against the interior walls. In one example, the piston seals 459a, 459b are formed of a flexible, but reduced friction material, such as PTFE rubber O-rings. In this example, the piston seals 459a, 459b may prevent fluid from leaking around the piston 453, ensuring a strong vacuum force can be generated, without degrading performance of the pump by introducing substantial drag on the movement of the piston 453 within the pump chamber.

In these embodiments, the piston 453 may include one or more annular grooviest hat extend around the outer surface thereof. In the example shown in FIG. 15, there may be two annular grooves 458a, 458b that are adjacent to one another and each configured to receive a piston seal 459a, 459b. Specifically, the first piston seal 459a is received in the first annular groove 458a and the second piston seal 459b is received in the second annular groove 458b. In some embodiments, the piston seals 459a, 459b may be oriented within the annular grooves 458a, 458b in opposite orientations. For example, in embodiments where the first piston seal 459a is a U-cup, the piston seal 459a may be oriented such that the open end of the seal is arranged facing upwards towards the pump outlet. Continuing with this example, when the second piston seal 459b is a U-cup the piston seal 459b may be oriented such that the open end of the seal is arranged facing downwards or away from the pump outlet. In this manner, the two U-cups may be arranged to have the closed end facing towards one another and the open ends facing away from one another. This configuration may help enable a tight seal as the sealing portions of the piston seals 459a, 459b may be configured to seal in opposite directions within the pump chamber 390.

A dampener 461 (see FIG. 15) may be included to help reduce noise and vibrations from being transmitted outside of the housing 102. In one example, the dampener 461 may be configured as a foam or other similar material that can absorb energy, such as sound waves, to help prevent their transmission. In one embodiment, the dampener 461 may be positioned to be adjacent to the battery 210, but in other embodiments, the dampener 461 may be positioned in other locations.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. An oral irrigator comprising:
a housing defining a housing cavity; and
a chassis received within the housing cavity, wherein a plurality of components received within the housing cavity are mounted to the chassis and inserted into the housing cavity via the chassis.

2. The oral irrigator of claim 1, wherein all the components received within the housing cavity are secured to the chassis.

3. The oral irrigator of claim 2, wherein the housing comprises a first alignment feature and the chassis comprises a second alignment feature, wherein the first alignment feature and the second alignment feature engage to align the chassis within the housing cavity.

4. The oral irrigator of claim 3, wherein the first alignment feature and second alignment feature are secured together to anchor the chassis in position within the housing cavity.

5. The oral irrigator of claim 3, wherein the first alignment feature comprises two ribs and the second alignment feature comprises an edge of the chassis.

6. The oral irrigator of claim 3, wherein the first alignment feature comprises a post and the second alignment feature comprises a tab that seats on the post.

7. The oral irrigator of claim 6, wherein:
the housing further comprises a reservoir aperture defined through a bottom surface thereof and a boss surrounding the reservoir aperture; and
the chassis comprises a drain port, wherein the drain port interacts with the boss to align the chassis within the housing such that the drain port aligns with the reservoir aperture.

8. The oral irrigator of claim 7, wherein the plurality of components comprise a motor, a gear driven by the motor, a piston, a connecting rod including a first end coupled to the gear and a second end coupled to the piston, and a pump body defining a pump chamber in which the piston is received, wherein the chassis defines a wall at least partially surrounding the first end of the connecting rod, and wherein the pump body includes a cap that covers the wall to enclose the first end of the connecting rod.

9. The oral irrigator of claim 8, wherein the motor and the connecting rod are positioned on opposite sides of the chassis.

10. The oral irrigator of claim 9, wherein the plurality of components further comprises a battery, and wherein the battery is positioned along an edge of the chassis adjacent the motor and the connecting rod.

11. The oral irrigator of claim 10, wherein the plurality of components further comprise a seal positioned between the wall and the cap to seal an interface between the wall and the cap.

12. The oral irrigator of claim 11, wherein the seal is overmolded on an outer edge of the wall.

13. The oral irrigator of claim 12, wherein the cap comprises at least one securing tab configured to secure the cap to the wall.

14. The oral irrigator of claim 13, wherein the wall interacts with the housing to align the chassis within the housing.

15. An oral irrigator comprising:
a housing;
a tip coupled to the housing;
a reservoir coupled to the housing and in fluid communication with the tip:
a pump coupled to the housing and configured to pump fluid from the reservoir to the tip; and
a vent tube positioned within the housing, the vent tube fluidly coupled to the reservoir and an external environment of the housing to enable air to enter into the reservoir from the external environment.

16. The oral irrigator of claim 15, further comprising a vent cover positioned over a first end of the vent to prevent water from entering into the vent tube.

17. The oral irrigator of claim 16, wherein the vent tube is defined as a flow passage in a wall of the housing.

18. The oral irrigator of claim 17, wherein the flow passage is fluidly coupled to the reservoir by a first vent hole extending through a bottom surface of the housing at a first end of the flow passage, and wherein the flow passage is fluidly coupled to a latch compartment by a second vent hole at a second end of the flow passage.

19. The oral irrigator of claim 18, further comprising:
a vent cover positioned over the second vent hole to prevent water from entering into the latch compartment; and
a hose positioned between the pump and the reservoir that fluidly couples the reservoir to the pump,
wherein the reservoir is movable between a first position and a second position relative to the housing.

20. (canceled)

21. (canceled)

22. An oral irrigator comprising:
a reservoir;
a housing; and
a pump coupled to the housing and configured to pump fluid from the reservoir to a tip, the pump comprising:
a pump chamber;
a piston positioned within the pump chamber;
a first piston seal positioned around the piston and configured to seal against an interior wall of the piston chamber;
a second piston seal positioned around the piston and configured to seal against the interior wall of the piston chamber, wherein the first piston seal is arranged in a first orientation relative to the piston and the second piston seal is arranged in a second orientation, different from the first orientation, relative to the piston;
wherein:
the first piston seal and the second piston seal each comprise a U-cup seal including a closed end; and
the first piston seal and the second piston seal are arranged such that the closed ends of the U-cup seals are directed towards each other; and
the piston defines a first annular groove and a second annular groove, wherein the first piston seal seats within the first annular groove and the second piston seal seats within the second annular groove.

23. (canceled)

24. (canceled)
